(19) United States
(12) Patent Application Publication
(10) Pub. No.: US 2009/0008497 A1
(43) Pub. Date: Jan. 8, 2009

(54) Rotary-wing miniature gyro helicopter

(75) Inventors: Jeffrey James Corsiglia, Toronto (CA); Charles Sink, Friday Harbor, WA (US)

Correspondence Address: COHEN, PONTANI, LIEBERMAN & PAVANE LLP, 551 FIFTH AVENUE, SUITE 1210, NEW YORK, NY, 10176, US

(73) Assignee: Spin Master Ltd.

(21) Appl. No.: 11/825,167

(22) Filed: Jul. 5, 2007

(51) Int. Cl. B64C 27/06

(52) U.S. Cl. 244/17.11

(57) ABSTRACT

There is provided a gyro helicopter generally comprising a fuselage, a rotor mast extending upwardly from the top of the fuselage, a rotor adapted to autorotate when the gyro helicopter moves forward, and drive means mounted to the fuselage for driving the gyro helicopter in at least a forward direction and for causing the gyro helicopter to perform yawing motions. The rotor of the gyro helicopter includes a hub mounted to the rotor mast, at least two rotor arms extending radially from the hub, and at least two corresponding lifting blades, a leading edge of each of the lifting blades fixedly mounted to a corresponding one of the rotor arms. The rotor arms are adapted to twist in a first direction while an upward force is applied to the blades, raising the trailing edge of the blades above the plane of the rotor, and the rotor arms are adapted to twist in a second direction while a downward force is applied to the blades, the twisting in a second direction lowering the trailing edge of the blades below the plane of the rotor.

### BACKGROUND OF THE INVENTION

1. Field of the Invention

This invention relates to rotary-wing vehicles and in particular to miniature, rotary-wing gyro helicopters.

2. Description of the Related Art

A gyro helicopter, or autogyro, is a flying machine. Like a regular helicopter, it is a rotary-wing aircraft, which means that it has a rotor to provide lift instead of wings like conventional airplanes. Unlike a regular helicopter, the rotor is not powered by an engine. The rotor is made to spin by aerodynamic forces, through a phenomenon called autorotation.

Since the rotor of a gyro helicopter is not powered, a gyro helicopter needs a separate source for forward propulsion, like an airplane. Forward propulsion can be provided by, for example, propellers. When a gyro helicopter is propelled forward, air is forced up through the rotor blades, that is, through the area swept by the blades or the “rotor disk”, which starts the blades turning. The rotation of the rotor blades provides not only lift, but also accelerates the rotation rate of the blades until the rotor blades turn at a stable speed with the drag and thrust forces in balance.

Flying toys incorporating rotor autorotation are known. However, getting the rotor spinning fast enough for flight has always been very difficult for these types of flying toys, usually requiring the user to walk or run with the toy to force enough air through the rotor to start it spinning fast enough to generate lift. Stability and intuitive control while in flight have also posed problems for these toys.

### SUMMARY OF THE INVENTION

The gyro helicopter described herein seeks to overcome the above disadvantages. The gyro helicopter uses forward motion to force air up through the gyro helicopter's rotor blades, causing the blades to spin through autorotation. The spinning rotor creates the lift force necessary for flight and creates a gyroscopic force that stabilizes the entire vehicle allowing for intuitive control by a user. Gyroscopic stability of the gyro helicopter is further enhanced by blade tip weights that also act as blade tip protectors.

The rotor of the applicants' gyro helicopter is designed to allow a user to get the rotor spinning fast enough for flight while the user is standing still. The user can raise and lower the gyro helicopter by hand, in other words, “pump” the gyro helicopter, to get the rotor spinning. When the rotor is spinning fast enough to generate lift, the user simply releases the gyro helicopter. The gyro helicopter's drive means propel the gyro helicopter forward and the forward motion keeps the rotor spinning.

Accordingly, there is described herein embodiments of the applicants' gyro helicopter. In particular, in one aspect, there is provided a rotary-wing gyro helicopter comprising: a fuselage; a rotor mast extending upwardly from the top of the fuselage; a rotor comprising: a hub rotatably mounted to the rotor mast; at least two rotor arms extending radially outwardly from the hub; at least two corresponding lifting blades, a leading edge of each of the at least two lifting blades fixedly mounted to a corresponding one of the at least two rotor arms, each lifting blade also having a trailing edge and a chord line at a predetermined angle relative to the plane of the rotor; drive means mounted to the fuselage for driving the gyro helicopter in at least a forward direction and for causing the gyro helicopter to perform yawing motions; and control means for controlling the drive means, wherein the rotor is adapted to autorotate when the gyro helicopter moves in the forward direction; wherein the rotor arms are adapted to resiliently twist axially in a first direction while an upward force is applied to the blades, the twisting in a first direction raising the trailing edge of the blades above the plane of the rotor; and wherein the rotor arms are adapted to resiliently twist axially in a second direction while a downward force is applied to the blades, the twisting in a second direction lowering the trailing edge of the blades below the plane of the rotor.

To provide stability, the lifting blades may comprise weights fixedly attached to their tips. Advantageously, the rotor is adapted to rotate when the downward force is applied to the blades or when the upward force is applied to the blades. The upward force is applied to the blades by lowering the gyro helicopter and the downward force is applied to the blades by raising the gyro helicopter, this lowering and raising referred to as a “pump” action. The rotors arms may be made of acrylonitrile butadiene styrene plastic (ABS). Additionally, a tail may be extended rearwardly from the aft of the fuselage, the tail including a vertical tail fin to provide improved directional stability to the gyro helicopter. Two winglets may be included, extending laterally away from opposite sides of the fuselage at a predetermined dihedral angle.

The drive means may comprise left and right propeller drives oppositely located on the left and right sides of the gyro helicopter respectively. The left and right propeller drives may be independently rotatable at independent speeds to thereby apply a differential thrust causing the gyro helicopter to rotate either clockwise or counterclockwise on a horizontal plane. The control means may be remotely controllable. The rotor mast extends upwardly at an angle towards a side of the fuselage under the lifting blades that are advancing blades when the gyro helicopter moves in the forward direction, the angle preferably being in the range of about 7.5 degrees from the vertical.

### BRIEF DESCRIPTION OF THE DRAWINGS

In the drawings:

Embodiments of the gyro helicopter will now be described by way of example and with reference to the accompanying drawings in which:

FIG. 1 shows a perspective view of one of the applicants' gyro helicopters.

FIG. 2 shows a perspective view from below the gyro helicopter of FIG. 1.

FIG. 3 shows an exploded perspective view of the gyro helicopter of FIG. 1.

FIG. 4 shows a simplified block diagram of a control means and power assembly for the applicants' gyro helicopter.

FIG. 5 shows a simplified block diagram of a remote control unit for the applicants' gyro helicopter.

### DETAILED DESCRIPTION OF THE PRESENTLY PREFERRED EMBODIMENTS

The rotary-wing gyro helicopters are herein described in detail. One of the gyro helicopters generally comprises a fuselage, a rotor mast extending upwardly from the top of the fuselage, a rotor adapted to autorotate when the gyro helicopter moves forward, and drive means mounted to the fuselage for driving the gyro helicopter in at least a forward direction and for causing the gyro helicopter to perform yawing motions. The rotor of the gyro helicopter includes a hub mounted to the rotor mast, at least two rotor arms extending radially from the hub, and at least two lifting blades, the leading edge of one of the blades fixedly mounted to each of the rotor arms. The rotor arms are adapted to twist in a first direction while an upward force is applied to the blades, raising the trailing edge of the blades above the plane of the rotor, and the rotor arms are adapted to twist in a second direction while a downward force is applied to the blades, the twisting in a second direction lowering the trailing edge of the blades below the plane of the rotor.

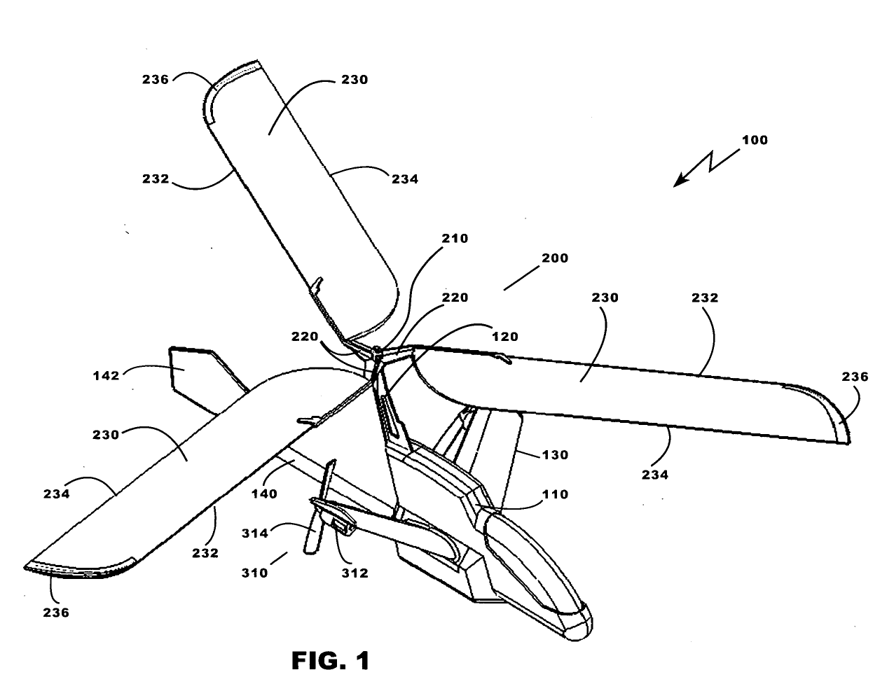

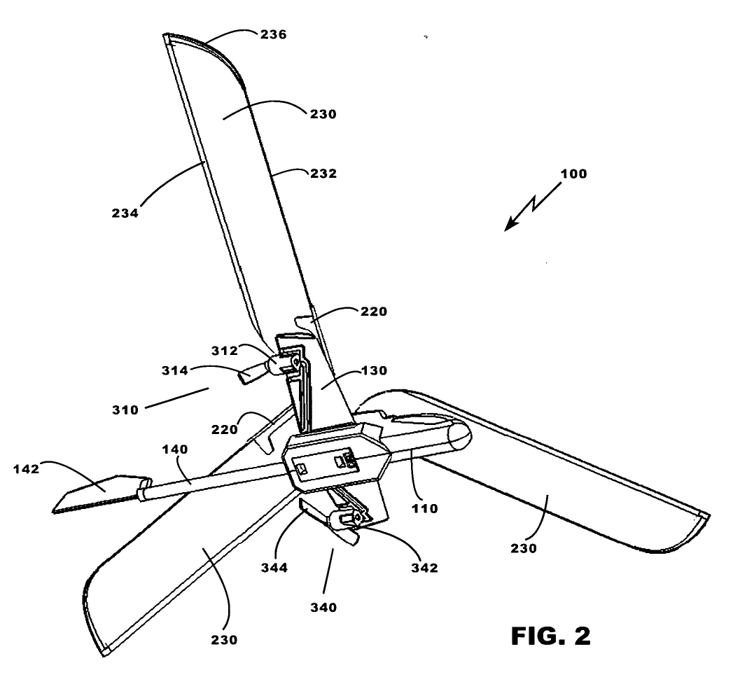

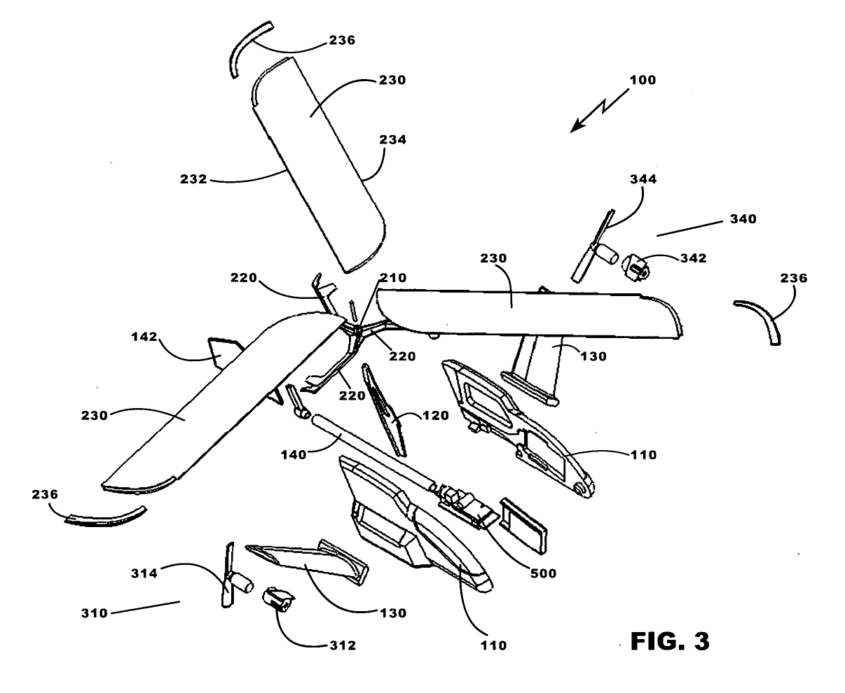

FIGS. 1 to 3 show an embodiment of the gyro helicopter 100. The gyro helicopter comprises fuselage 110. A rotor mast 120 extends upwardly from the top of the fuselage. Winglets 130 extend laterally away from opposite sides of the fuselage 110 at a predetermined dihedral angle. The winglets 130 provide the gyro helicopter 100 with a dihedral roll stabilizing effect as well as a place to mount propeller assemblies. Specifically, dihedral winglets 130 help the gyro helicopter return to level flight after the gyro helicopter has executed a turn.

The gyro helicopter 100 may also comprise a tail 140 for improving the directional stability of the gyro helicopter. The tail 140 extends rearwardly from the aft of the fuselage 110 and comprises a vertical fin 142 located approximate the distal end of tail 140. Like an airplane, the vertical fin 142 creates a stabilizing force that will tend to keep the gyro helicopter flying in a straight line unless the gyro helicopter is executing a turn.

Also with reference to the embodiment of FIGS. 1 to 3, the gyro helicopter comprises a rotor 200. Rotor 200 has a hub 210 rotatably mounted to rotor mast 120. At least two rotor arms 220 extend radially outwardly from the hub 210. As shown in FIGS. 1 to 3, three rotor arms 220 extend radially from the hub 210, spaced apart equidistantly. The rotor arms are made from an inherently resiliently flexible material, for example, acrylonitrile butadiene styrene (“ABS”) plastic.

The rotor 200 comprises at least two lifting blades 230 each have a leading edge 232 and a trailing edge 234. The leading edge 232 is the front edge of lifting blades 230, which faces the direction of the rotor's rotation. The leading edge of one of the lifting blades is mounted to each of the rotor arms 220. For aerodynamic efficiency, the lifting blades 230 can have an airfoil shaped cross section.

The chord line of the lifting blades 230 is a straight line drawn from their leading edge 232 to their trailing edge 234. The lifting blades are mounted on rotor arms 220 such that their chord lines are at a predetermined angle relative to the plane of the rotor 200. Preferably the lifting blades 230 are parallel, at a 0 degree angle, to the plane of the rotor.

Blade tip weights 236 can be fixedly attached to the tips of the lifting blades 230. Weights 236 enhance the gyroscopic stability of the gyro helicopter 100 and also protect the tips of the lifting blades from damage.

When the rotor of a rotary-wing vehicle, such as gyro helicopter 100, is rotating, rotor blades that are moving in the same direction as the vehicle are called “advancing blades” and the blades moving in the opposite direction are called “retreating blades”. As a rotary-wing vehicle flies through the air, the advancing blades of the vehicle's rotor, over the left or right side of the vehicle depending on the direction of the rotor's rotation, generate more lift than the retreating blades, causing a rolling force. To counteract this rolling force, the rotor mast 120 of gyro helicopter 100 may extend upwardly at an angle towards the side of the fuselage under the lifting blades 230 that are advancing blades when gyro helicopter 100 is moving forward. In the embodiment shown in FIGS. 1 to 3, the rotor mast 120 may be angled towards the right side of the gyro helicopter 100. Preferably, the angle of the rotor mast is 7.5 degrees from the vertical.

The drive means of the gyro helicopter 100 are for driving the gyro helicopter in at least a forward direction and for causing the gyro helicopter to perform yawing motions. With reference to the embodiment of FIGS. 1 to 3, the drive means comprise, for example, two propeller assemblies, a right propeller assembly 310 and a left propeller assembly 340. The right and left propeller assemblies 310 and 340 provide forward and yaw movement of gyro helicopter 100. The propeller assemblies may be attached to the winglets 130 of the gyro helicopter.

Each propeller assembly comprises a propeller and a motor. Right propeller assembly 310 comprises a motor 312 and a propeller 314. Left propeller assembly 340 comprises a motor 342 and a propeller 344. Propellers 314, 344 provide forward thrust to the gyro helicopter when the propellers are spinning. Propellers 314, 344 can spin independently according to commands received from a control assembly 700. The propellers are used to move gyro helicopter 100 forward and in yaw movements (horizontal rotation clockwise or counterclockwise). Yaw movements can be produced by differentially increasing or decreasing the RPM of the propellers. Motors 312, 342 provide the rotation power for propellers 314, 344.

The control means of the gyro helicopter 100 are for controlling, at least, the drive means of the gyro helicopter. With reference to FIG. 4, control means are, for example, a control assembly 400. Control assembly 400 controls the operation of rotary-wing gyro helicopter 100, for example, the operation of the propeller assemblies, in particular, the movement of motors 312, 342.

Control assembly 400 may comprise toy-based electronics known in the art, for example, RX2C based electronics. Control assembly 400 may have remote control capabilities and may have a processing unit 410 and memory (not shown). A receiver 420 of control assembly 400 is for receiving remote control commands. Such a receiver may be of radio frequency (RF), as shown in FIG. 4, light such as infrared (IR), or sound such as ultra sound, or voice commands.

A power assembly 500 provides power to all drive means and control means of the gyro helicopter 100, for example, control assembly 400 and propeller assemblies 310, 340. Power assembly 500 may be a rechargeable battery, such as a lithium polymer cell, simple battery, capacitance device, super capacitor, micro power capsule, fuel cells, fuel or other micro power sources. Control assembly 400 may incorporate monitoring circuitry 430 for the power assembly 500.

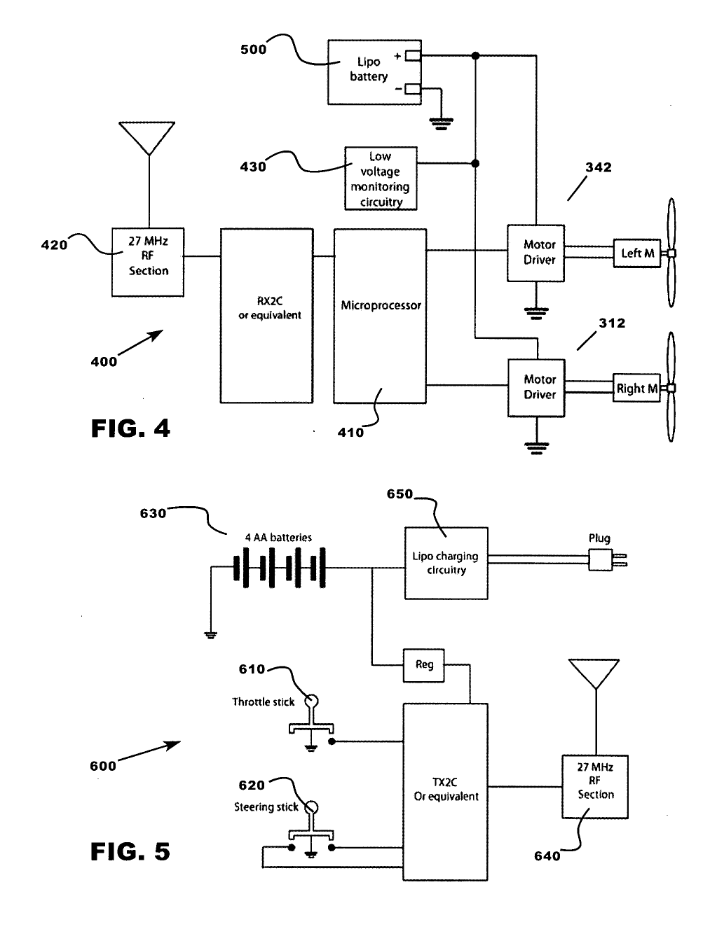

With reference to FIG. 5, a remote control unit 600 may preferably be used by an operator to control the gyro helicopter 100, in particular, for transmitting remote user commands to the control means of the gyro helicopter. Remote control unit 600 is adapted to transmit commands to control assembly 400. Remote control unit 600 may comprise toy-based electronics known in the art, for example, TX2C based electronics.

Remote control unit 600 comprises a throttle control, which may be a throttle stick 610 movable between an up and a down position, and a direction control, which may be a steering stick 620 movable between left, right and neutral positions, for controlling the forward movement of the gyro helicopter 100 in flight. User inputs at the remote control unit 600 are executed by the control means, for example, control assembly 400 of gyro helicopter 100. Moving the throttle stick 610 to the “up” position and the steering stick 620 to the “right” position may, for example, cause the control assembly to run the right motor 312 at 70% power and the left motor 342 at full power. This differential powering of motors 312 and 314 causes the gyro helicopter to turn by moving forward and to the right.

Remote control unit 600 comprises a power source, for example, four AA batteries 630, and a transmitter for transmission of remote control commands by a user. The transmitter is, for example, a wave radiation transducer such as an RF antenna 640 shown in FIG. 5. Remote control unit 600 may also have charging circuitry 650 for charging the power assembly 500 of gyro helicopter 100. The remote control unit 600 may also incorporate a power switch and indicators for various information such as power on/off, charging, battery status, and the like.

A description of the operation of one embodiment of the gyro helicopter 100 follows. The rotor 200 of the gyro helicopter is designed to allow a user to get the rotor spinning fast enough for flight while the user is standing still. The user can get the rotor spinning by raising and lowering the gyro helicopter 100 by hand, in other words, by “pumping” the gyro helicopter. The raising and lowering of the gyro helicopter is hereinafter referred to as a “pump action” comprising an “up-stroke” and a “down-stroke”. A pump action affects the inherently resiliently flexible material of the rotor arms 220 as follows. On the down-stroke of the pump action, the user lowers the gyro helicopter and the air beneath the gyro helicopter pushes back against the lower surface of the lifting blades 230, applying an upward force to the lifting blades. Since one edge, the leading edge 232, of the lifting blades is attached to the rotor arms 220, the lifting blades act as levers and transmit part of the upward force as torque to the rotor arms 220. In response to the torque, the portion of the flexible rotor arms between the lifting blades 230 and the hub 210 twists and the portion of the rotor arms attached to the lifting blades rotates axially in the direction of the torque. As the portion of the rotor arms fixedly attached to the lifting blades rotates, the lifting blades also rotate around the same axis. The rotation of the lifting blades 230 raises the trailing edge 234 of the lifting blades above the plane of the rotor 200 such that the chord line of the lifting blades is at an acute angle to the plane of the rotor. When the user ceases to lower the gyro helicopter and holds the gyro helicopter stationary, the lifting blades 230 return to their original configuration.

On the up-stroke of the pump action, the forces work in reverse. The user raises the gyro helicopter 100 and the air above the gyro helicopter pushes back against the upper surface of the lifting blades 230, applying a downward force to the lifting blades. The downward force twists the rotor arms in the opposite direction as an upward force, and the consequent rotation of the lifting blades lowers the trailing edge 234 of the lifting blades below the plane of the rotor 200 such that the chord line of the lifting blades is at an acute angle to the plane of the rotor. When the user ceases to raise the gyro helicopter and holds the gyro helicopter stationary, the lifting blades return to their original configuration.

The above described raising and lowering of the trailing edge 234 of the lifting blades 230 during pump actions creates a forward acting force on the lifting blades 230 causing the rotor 200 to rapidly spin up to flight rpm, preferably about 300 rpm. Preferably, a user will execute a full up and down pump action about once per second.

When the rotor is spinning fast enough to generate lift, the user releases the gyro helicopter 100. Once released, the gyro helicopter's drive means propel the gyro helicopter forward. The forward motion forces air up through the gyro helicopter's rotor 200, which keeps the lifting blades 230 spinning, through autorotation, preferably at about 300 rpm. The fast spinning rotor 200 creates the lift force necessary for flight and creates a gyroscopic force that stabilizes the entire gyro helicopter 100 allowing for intuitive control of the gyro helicopter by the user with remote control unit 600.

All of the above features provide an illustration of preferred embodiments of the gyro helicopter, but are not intended to limit the scope of the invention, which is fully described in the claims below.

We claim:

1. A rotary-wing gyro helicopter comprising:
a fuselage;
a rotor mast extending upwardly from the top of said fuselage;
a rotor comprising:
a hub rotatably mounted to said rotor mast;
at least two rotor arms extending radially outwardly from said hub;
at least two corresponding lifting blades, a leading edge of each of said at least two lifting blades fixedly mounted to a corresponding one of said at least two rotor arms, each lifting blade also having a trailing edge and a chord line at a predetermined angle relative to the plane of the rotor;
drive means mounted to said fuselage for driving the gyro helicopter in at least a forward direction and for causing the gyro helicopter to perform yawing motions; and
control means for controlling said drive means,
wherein said rotor is adapted to autorotate when the gyro helicopter moves in said forward direction;
wherein said rotor arms are adapted to resiliently twist axially in a first direction while an upward force is applied to said blades, said twisting in a first direction raising the trailing edge of said blades above the plane of the rotor; and
wherein said rotor arms are adapted to resiliently twist axially in a second direction while a downward force is applied to said blades, said twisting in a second direction lowering the trailing edge of said blades below the plane of the rotor.

2. The rotary-wing gyro helicopter of claim 1, wherein said lifting blades comprise weights fixedly attached to tips of said lifting blades.

3. The rotary-wing gyro helicopter of claim 1, wherein said rotor is adapted to rotate when said downward force is applied to said blades or when said upward force is applied to said blades.

4. The rotary-wing gyro helicopter of claim 1, wherein said upward force is applied to said blades by lowering the gyro helicopter and said downward force is applied to said blades by raising the gyro helicopter.

5. The rotary-wing gyro helicopter of claim 1, wherein said rotors arms are made of acrylonitrile butadiene styrene plastic.

6. The rotary-wing gyro helicopter of claim 1, additionally comprising a tail extending rearwardly from the aft of said fuselage, said tail including a vertical tail fin to provide improved directional stability to the gyro helicopter.

7. The rotary-wing gyro helicopter of claim 1, additionally comprising two winglets extending laterally away from opposite sides of said fuselage at a predetermined dihedral angle.

8. The rotary-wing gyro helicopter of claim 1, wherein said drive means comprise left and right propeller drives oppositely located on the left and right sides of the gyro helicopter respectively.

9. The rotary-wing gyro helicopter of claim 8, wherein said left and right propeller drives are independently rotatable at independent speeds to thereby apply a differential thrust causing the gyro helicopter to rotate either clockwise or counterclockwise on a horizontal plane.

10. The rotary-wing gyro helicopter of claim 1, wherein said control means are remotely controllable.

11. The rotary-wing gyro helicopter of claim 1, wherein said rotor mast extends upwardly at an angle towards a side of said fuselage under said lifting blades that are advancing blades when the gyro helicopter moves in said forward direction.

12. The rotary-wing gyro helicopter of claim 11, wherein said angle towards a side of said fuselage is 7.5 degrees from the vertical.
